(19) United States
(12) Patent Application Publication
(10) Pub. No.: US 2018/0183041 A1
(43) Pub. Date: Jun. 28, 2018

(54) SULFUR-CONTAINING CARBON NANOTUBE ARRAYS AS ELECTRODES

(71) Applicant: William Marsh Rice University, Houston, TX (US)

(72) Inventors: James M. Tour, Bellaire, TX (US); Caitian Gao, Houston, TX (US); Lei Li, Houston, TX (US)

(73) Assignee: William Marsh Rice University, Houston, TX (US)

(21) Appl. No.: 15/735,283

(22) PCT Filed: Jun. 9, 2016
(86) PCT No.: PCT/US16/36697

§ 371 Date: Dec. 11, 2017

Related U.S. Application Data
(60) Provisional application No. 62/173,179, filed on Jun. 9, 2015.

(51) Int. Cl. H01M 4/133; H01M 4/36; H01M 4/587; H01M 4/38; H01M 4/66; H01M 4/80; H01M 4/136; H01M 4/1393; H01M 4/1397; H01M 4/04; H01M 10/052; C01B 32/168; C01B 32/194; H01G 11/36; H01G 11/86

(52) U.S. Cl. CPC H01M 4/133; H01M 2004/021; H01M 4/587; H01M 4/38; H01M 4/661; H01M 4/808; H01M 4/136; H01M 4/1393; H01M 4/1397; H01M 4/0404; H01M 4/0428; H01M 4/0483; H01M 4/0471; H01M 10/052; C01B 32/168; C01B 32/194; H01G 11/36; H01G 11/86; H01M 4/366

(57) ABSTRACT

Embodiments of the present disclosure pertain to electrodes that include a plurality of vertically aligned carbon nanotubes and sulfur associated with the vertically aligned carbon nanotubes. The electrodes may also include a substrate (e.g., a porous nickel foam) and a carbon layer (e.g., graphene film). In some embodiments, the carbon layer may be positioned between the substrate and the vertically aligned carbon nanotubes. In some embodiments, the electrodes may be in the form of a graphene-carbon nanotube hybrid material that includes: a graphene film; and vertically aligned carbon nanotubes covalently linked to the graphene film. In some embodiments, the electrodes of the present disclosure serve as cathodes or anodes in an energy storage device. Additional embodiments pertain to energy storage devices that contain the electrodes of the present disclosure. Further embodiments of the present disclosure pertain to methods of making the electrodes and incorporating them into energy storage devices.

### CROSS-REFERENCE TO RELATED APPLICATIONS

This application claims priority to U.S. Provisional Patent Application No. 62/173,179, filed on Jun. 9, 2015. The entirety of the aforementioned application is incorporated herein by reference.

### STATEMENT REGARDING FEDERALLY SPONSORED RESEARCH

This invention was made with government support under Grant No. FA9950-14-1-0111, awarded by the U.S. Department of Defense; and Grant No. FA9550-12-1-0035, awarded by the U.S. Department of Defense. The government has certain rights in the invention.

### BACKGROUND

Current sulfur-based electrodes have numerous limitations, including limited sulfur storage capacity, low Coulombic efficiency, and undesired capacity loss during operation. The present disclosure addresses the aforementioned limitations.

### SUMMARY

In some embodiments, the present disclosure pertains to electrodes that include: a plurality of vertically aligned carbon nanotubes; and sulfur associated with the vertically aligned carbon nanotubes. In some embodiments, the vertically aligned carbon nanotubes include vertically aligned single-walled carbon nanotubes that are in the form of an array.

In some embodiments, the electrodes of the present disclosure also include a substrate that serves as a current collector (e.g., a porous nickel foam). In some embodiments, the electrodes of the present disclosure also include a carbon layer that is positioned between a substrate and the vertically aligned carbon nanotubes. In some embodiments, the carbon layer includes a graphene film. In some embodiments, the vertically aligned carbon nanotubes are covalently linked to the carbon layer.

In some embodiments, the electrodes of the present disclosure are in the form of a graphene-carbon nanotube hybrid material that includes: a graphene film; and vertically aligned carbon nanotubes covalently linked to the graphene film. In some embodiments, the vertically aligned carbon nanotubes are covalently linked to the graphene film through carbon-carbon bonds at one or more junctions between the vertically aligned carbon nanotubes and the graphene film.

In more specific embodiments, the electrodes of the present disclosure include a substrate, a graphene film associated with the substrate, vertically aligned carbon nanotubes covalently linked to the graphene film through carbon-carbon bonds at one or more junctions between the vertically aligned carbon nanotubes and the graphene film, and sulfur associated with the vertically aligned carbon nanotubes. In some embodiments, the sulfur is also associated with the graphene film. In some embodiments, the vertically aligned carbon nanotubes are grown seamlessly on the graphene film through the use of a catalyst that includes a metal and a buffer (e.g., a buffer layer).

Sulfur may be associated with the vertically aligned carbon nanotubes of the present disclosure in various manners. For instance, in some embodiments, sulfur is diffused throughout the vertically aligned carbon nanotubes. In some embodiments, sulfur is dispersed on surfaces of the vertically aligned carbon nanotubes. In some embodiments, sulfur constitutes more than about 60 wt % of the electrode. In some embodiments, sulfur constitutes from about 50 wt % to about 90 wt % of the electrode. In some embodiments, sulfur constitutes from about 50 wt % to about 200 wt % of the electrode.

In some embodiments, the electrodes of the present disclosure serve as components of an energy storage device (e.g., cathodes or anodes in an energy storage device). Additional embodiments of the present disclosure pertain to energy storage devices that contain the electrodes of the present disclosure. In some embodiments, the energy storage device includes, without limitation, capacitors, lithium-sulfur capacitors, batteries, photovoltaic devices, photovoltaic cells, transistors, current collectors, fuel cell devices, water-splitting devices, and combinations thereof. In some embodiments, the energy storage device is a battery, such as a lithium-sulfur battery. In some embodiments, the energy storage device is a cathode. In some embodiments, the energy storage device is a positive electrode.

Additional embodiments of the present disclosure pertain to methods of making the electrodes of the present disclosure. In some embodiments, the methods of the present disclosure include a step of applying sulfur to a plurality of vertically aligned carbon nanotubes such that the sulfur becomes associated with the vertically aligned carbon nanotubes. In more specific embodiments, the electrodes of the present disclosure are fabricated by associating a graphene film with a substrate (e.g., a metal substrate); applying a catalyst (e.g., a metal and a buffer layer) and a carbon source to the graphene film; growing the vertically aligned carbon nanotubes on the graphene film to form a graphene-carbon nanotube hybrid material; and applying sulfur to the plurality of vertically aligned carbon nanotubes such that the sulfur becomes associated with the vertically aligned carbon nanotubes and optionally the graphene film. In some embodiments, the association of the graphene film with the substrate occurs by growing the graphene film on the substrate. In some embodiments, the methods of the present disclosure also include a step of incorporating the formed electrodes into an energy storage device.

### DESCRIPTION OF THE FIGURES

FIG. 1 illustrates the formation of electrodes (FIG. 1A), a structure of a formed electrode (FIG. 1B), and the use of the formed electrodes in a battery (FIG. 1C).

FIG. 2 provides a scheme of the fabrication process of graphene-carbon nanotube hybrid materials (GCNTs), their association with sulfur (GCNT/S), and the subsequent melting of the sulfur (SGCNT). The corresponding magnifications of GCNTs and SGCNTs on a porous nickel foam are also shown.

FIG. 3 provides data relating to the characterization of GCNTs and GCNT/S on porous nickel (Ni) foam. FIG. 3A provides photographs of a porous Ni foam, graphene on the Ni foam, GCNT on the Ni foam, and GCNT/S on the Ni foam (from the left to the right), respectively. FIG. 3B shows the scanning electron microscopy (SEM) image of graphene on a Ni foam with catalyst. FIGS. 3C-E show SEM images of GCNT on a Ni foam at different magnifications. FIGS. 3F-H show SEM images of GCNT/S at different magnifications.

FIG. 4 provides additional data relating to the characterization of GCNTs and GCNT/S. FIG. 4A provides Raman spectroscopy of sulfur, GCNTs and GCNT/S, respectively. FIG. 4B provides x-ray photoelectron spectroscopy (XPS) of GNCT/S. FIG. 4C shows a C is XPS fine spectra. FIG. 4D shows an S2p fine spectra. The C1s peak of 284.5 eV was used as the standard peak to correct the data.

FIG. 5 shows the charge-discharge profile of a GCNT/S cathode at the first, second, and third cycles.

FIG. 6 shows data relating to the cycling performance of GCNT/S cathodes at 0.5 C.

FIG. 7 shows data relating to the rate capability of GCNT/S cathodes.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The demand for energy storage systems employed in daily used electronics (e.g., cell phones and laptops) and electric vehicles continues to increase. Lithium ion batteries (LIBs) have been widely applied in energy storage systems for over two decades. However, limitations in cathode capacity compared with that of anodes have obstructed the advancement of energy storage systems, including LIBs. For instance, the commercially used lithium cobalt oxide (LiCoO₂) cathodes cannot be charged to more than 50% of theoretical capacity, thereby providing a capacity of less than 140 mAh/g. Moreover, the loss of oxygen from the cathodes can lead to chemical and structural instabilities.

The lithium-sulfur system is one of the most promising candidates to solve the aforementioned problems, as sulfur exhibits a high theoretical specific capacity of 1675 mAhg⁻¹ and a low cost when compared with the currently used oxide and phosphate cathodes. In addition, sulfur is an abundant and environmentally friendly material.

Despite advantages, the major impediments to the development of lithium-sulfur (Li—S) batteries are the low active material utilization and the capacity degradation on repeated charge and discharge cycles. Moreover, the sulfur or sulfur-containing organic compounds that are utilized in Li—S batteries are highly electrically and ionically insulating. As such, the compounds can be reduced to solid precipitates (e.g., Li₂S₂, and Li₂S), thereby resulting in severe capacity loss. Moreover, the diffusible sulfur materials (e.g., polysulphides) that shuttle between the anode and the cathode can lead to low Coulombic efficiency.

In response to the aforementioned challenges, sulfur has always been combined with other materials to construct composite materials with high conductivity and stable cyclability. For instance, carbon materials (e.g., graphene, carbon nanofibers, and carbon nanotubes) have been applied as matrices for sulfur. However, the cycling and rate stabilities of such materials have been limited due to low conductivity. Furthermore, the sulfur loading capacities of such materials have remained less than 60%, thereby further restricting their conductivities.

As such, a need exists for improved sulfur-containing electrodes. Various embodiments of the present disclosure address this need.

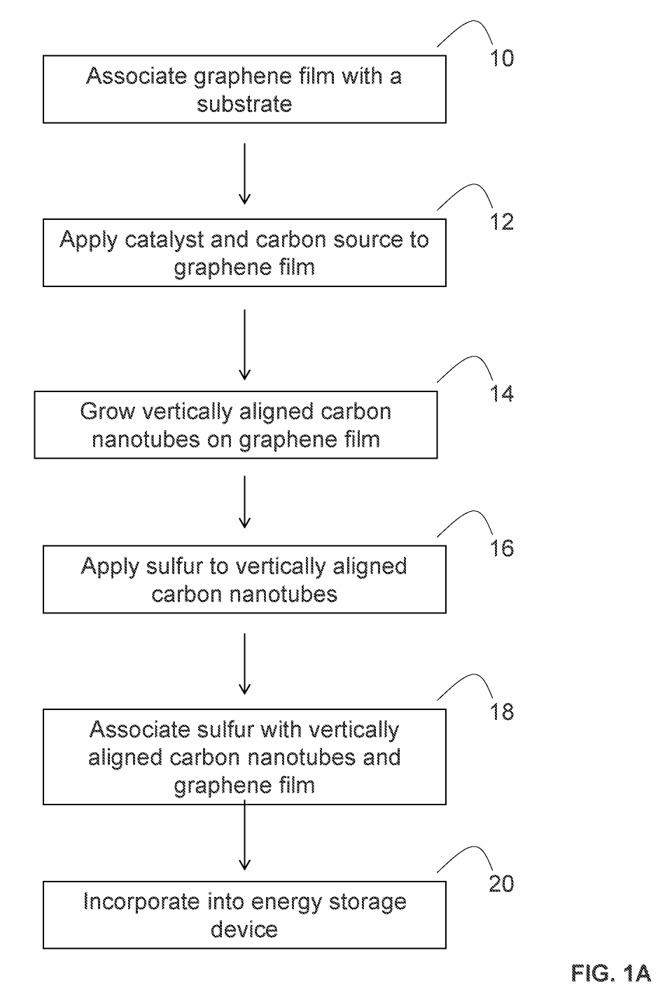

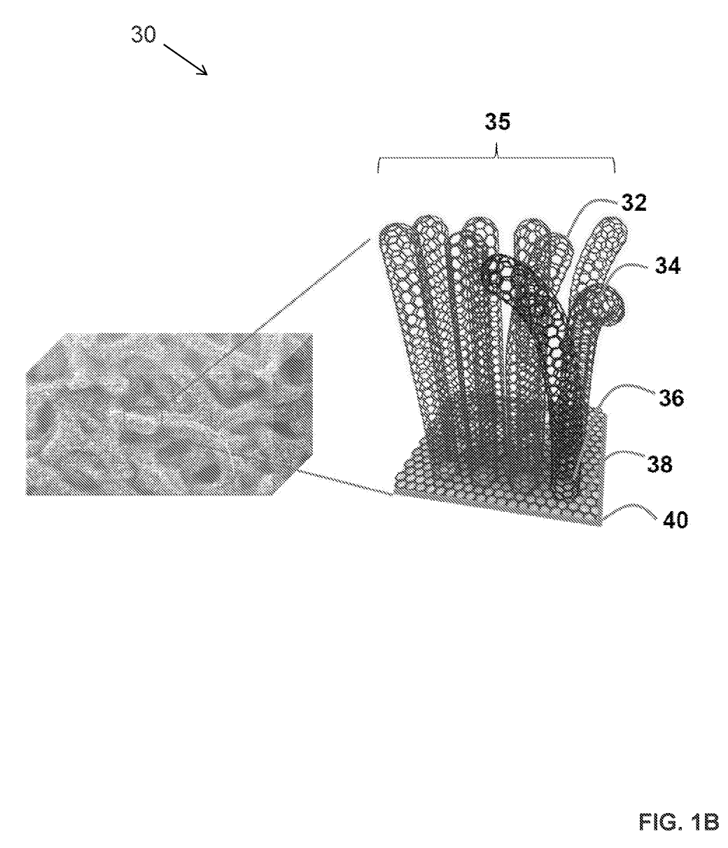

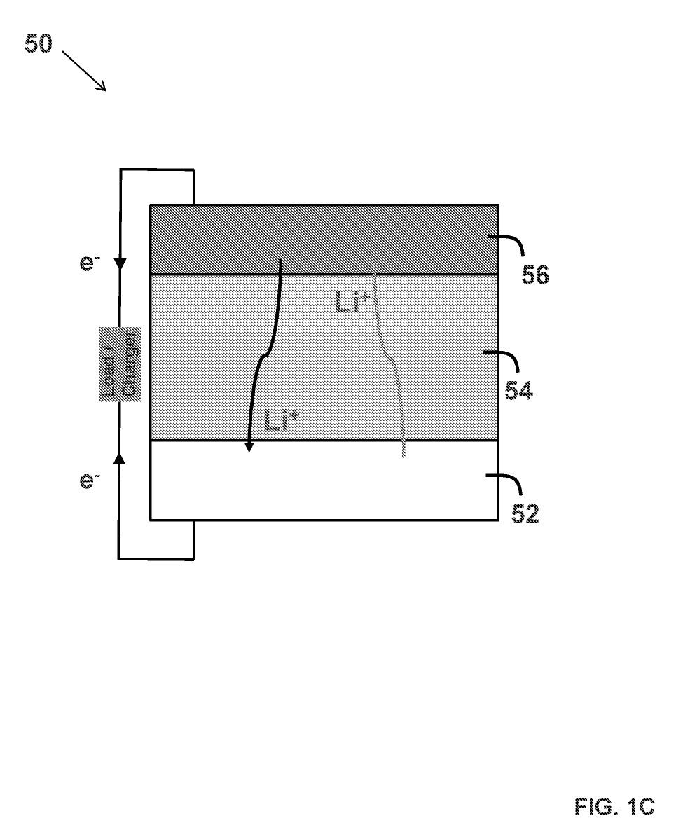

In some embodiments, the present disclosure pertains to methods of forming electrodes. In some embodiments, the methods of the present disclosure include applying sulfur to a plurality of vertically aligned carbon nanotubes such that the sulfur becomes associated with the vertically aligned carbon nanotubes. In more specific embodiments illustrated in FIG. 1A, the methods of the present disclosure include associating a graphene film with a substrate (step 10); applying a catalyst (e.g., a metal and a buffer layer) and a carbon source to the graphene film (step 12); growing the vertically aligned carbon nanotubes on the graphene film to form a graphene-carbon nanotube hybrid material (step 14); and applying sulfur to the plurality of vertically aligned carbon nanotubes (step 16) such that the sulfur becomes associated with the vertically aligned carbon nanotubes and optionally the graphene film (step 18). In some embodiments, the methods of the present disclosure also include a step of incorporating the formed electrode as a component of an energy storage device (step 20).

In additional embodiments, the present disclosure pertains to the formed electrodes. In some embodiments, the electrodes of the present disclosure include a plurality of vertically aligned carbon nanotubes and sulfur associated with the vertically aligned carbon nanotubes. In some embodiments, the electrodes of the present disclosure also include a substrate and a carbon layer.

In more specific embodiments illustrated in FIG. 1B, the electrodes of the present disclosure can be in the form of electrode 30, which includes sulfur 32, vertically aligned carbon nanotubes 34, graphene film 38, and substrate 40. In this embodiment, vertically aligned carbon nanotubes 34 are in the form of an array 35. Moreover, the vertically aligned carbon nanotubes are covalently linked to graphene film 38 through seamless junctions 36. In addition, sulfur 32 is associated with vertically aligned carbon nanotubes 34 by diffusion throughout the vertically aligned carbon nanotubes and dispersion on surfaces of the vertically aligned carbon nanotubes. Sulfur 32 may also be associated with graphene film 38.

Further embodiments of the present disclosure pertain to energy storage devices that contain the electrodes of the present disclosure. For instance, as illustrated in FIG. 1C, the electrodes of the present disclosure can be utilized as components of battery 50, which contains cathode 52, anode 56, and electrolytes 54. In this embodiment, the electrodes of the present disclosure can serve as cathode 52 or anode 56.

As set forth in more detail herein, the methods and electrodes of the present disclosure can utilize various types of vertically aligned carbon nanotubes. Moreover, various amounts of sulfur may be associated with the vertically aligned carbon nanotubes in various manners. Furthermore, the electrodes of the present disclosure can be utilized as components of various energy storage devices.

Vertically Aligned Carbon Nanotubes

The electrodes of the present disclosure can include various types of vertically aligned carbon nanotubes. For instance, in some embodiments, the vertically aligned carbon nanotubes include, without limitation, single-walled carbon nanotubes, double-walled carbon nanotubes, triple-walled carbon nanotubes, multi-walled carbon nanotubes, ultra-short carbon nanotubes, small diameter carbon nanotubes, pristine carbon nanotubes, functionalized carbon nanotubes, and combinations thereof. In some embodiments, the vertically aligned carbon nanotubes include vertically aligned single-walled carbon nanotubes.

In some embodiments, the vertically aligned carbon nanotubes of the present disclosure include pristine carbon nanotubes. In some embodiments, the pristine carbon nanotubes have little or no defects or impurities.

In some embodiments, the vertically aligned carbon nanotubes of the present disclosure include functionalized carbon nanotubes. In some embodiments, the functionalized carbon nanotubes include sidewall-functionalized carbon nanotubes. In some embodiments, the functionalized carbon nanotubes include one or more functionalizing agents. In some embodiments, the functionalizing agents include, without limitation, oxygen groups, hydroxyl groups, carboxyl groups, epoxide moieties, and combinations thereof.

In some embodiments, the sidewalls of the vertically aligned carbon nanotubes of the present disclosure contain structural defects, such as holes. In some embodiments, carbons at the edges of the structural defects (e.g., holes) are terminated by one or more atoms or functional groups (e.g., hydrogen, oxygen groups, hydroxyl groups, carboxyl, groups, epoxide moieties, and combinations thereof).

The vertically aligned carbon nanotubes of the present disclosure can be in various forms. For instance, in some embodiments, the vertically aligned carbon nanotubes are in the form of at least one of carbon nanotube arrays, carbon nanotube forests, carbon nanotube bundles, carbon nanotube networks, and combinations thereof. In some embodiments, the vertically aligned carbon nanotubes are in the form of carbon nanotube networks. In some embodiments, the vertically aligned carbon nanotubes are in the form of an array (e.g., array 35 in FIG. 1B). In some embodiments, the array is in the form of a carpet or a forest. In some embodiments, the array is in the form of superlattices held together by van der Waals interactions.

In some embodiments, the vertically aligned carbon nanotubes of the present disclosure are in the form of carbon nanotube bundles that include a plurality of channels. In some embodiments, the carbon nanotube bundles have inter-tube spacings ranging from about 3 Å to about 20 Å. In some embodiments, the carbon nanotube bundles have inter-tube spacings of about 3.4 Å. In some embodiments, the carbon nanotube bundles have channels with sizes that range from about 5 Å to about 20 Å. In some embodiments, the carbon nanotube bundles have channels with sizes of about 6 Å.

The vertically aligned carbon nanotubes of the present disclosure can have various angles relative to a base layer (e.g., a substrate, such as a metal substrate; or a carbon layer, such as a graphene film). For instance, in some embodiments, the vertically aligned carbon nanotubes of the present disclosure have angles that range from about 45° to about 90°. In some embodiments, the vertically aligned carbon nanotubes of the present disclosure have angles that range from about 75° to about 90°. In some embodiments, the vertically aligned carbon nanotubes of the present disclosure have an angle of about 90°.

The vertically aligned carbon nanotubes of the present disclosure can also have various thicknesses. For instance, in some embodiments, the vertically aligned carbon nanotubes of the present disclosure have a thickness ranging from about 10 μm to about 2 mm. In some embodiments, the vertically aligned carbon nanotubes of the present disclosure have a thickness ranging from about 10 μm to about 500 μm. In some embodiments, the vertically aligned carbon nanotubes of the present disclosure have a thickness ranging from about 10 μm to about 100 μm. In some embodiments, the vertically aligned carbon nanotubes of the present disclosure have a thickness of about 50 μm. In some embodiments, the vertically aligned carbon nanotubes of the present disclosure have a thickness of about 10 μm.

Substrates

In some embodiments, the electrodes of the present disclosure may also include a substrate (e.g., substrate 40 in FIG. 1B). In some embodiments, the substrate serves as a current collector. In some embodiments, the substrate and the vertically aligned carbon nanotubes serve as a current collector.

Various substrates may be utilized in the electrodes of the present disclosure. In some embodiments, the substrate includes a metal substrate. In some embodiments, the substrate includes a porous substrate. In some embodiments, the substrate includes, without limitation, nickel, cobalt, iron, platinum, gold, aluminum, chromium, copper, magnesium, manganese, molybdenum, rhodium, ruthenium, silicon, silicon carbide, tantalum, titanium, tungsten, uranium, vanadium, zirconium, silicon dioxide, aluminum oxide, boron nitride, carbon, carbon-based substrates, diamond, graphite, graphoil, steel, alloys thereof, foils thereof, foams thereof, and combinations thereof. In some embodiments, the substrate includes a copper substrate, such as a copper foil.

In some embodiments, the substrate includes a porous substrate, such as a porous nickel foam. In some embodiments, the porous substrate has a plurality of micropores, nanopores, mesopores, and combinations thereof.

The vertically aligned carbon nanotubes of the present disclosure may be associated with a substrate in various manners. For instance, in some embodiments, the vertically aligned carbon nanotubes of the present disclosure are substantially perpendicular to the substrate. In some embodiments, the vertically aligned carbon nanotubes of the present disclosure are indirectly associated with a substrate through a carbon layer.

Carbon Layers

In some embodiments, the electrodes of the present disclosure may also include a carbon layer. The carbon layer may have various arrangements in the electrodes of the present disclosure. For instance, in some embodiments, the carbon layer is positioned between a substrate and the vertically aligned carbon nanotubes. In some embodiments, the vertically aligned carbon nanotubes are directly associated with a carbon layer. In some embodiments, the vertically aligned carbon nanotubes are covalently linked to a carbon layer.

In some embodiments, the vertically aligned carbon nanotubes are covalently linked to a carbon layer while the carbon layer is associated with a substrate. In some embodiments, the carbon layer is covalently linked to a substrate. In some embodiments, the carbon layer is non-covalently linked to a substrate through various interactions, such as ionic interactions, acid-base interactions, hydrogen bonding interactions, pi-stacking interactions, van der Waals interactions, adsorption, physisorption, self-assembly, stacking, packing, sequestration, and combinations thereof. In some embodiments, the carbon layer is non-covalently linked to a substrate through van der Waals interactions.

The electrodes of the present disclosure can include various carbon layers. For instance, in some embodiments, carbon layers include, without limitation, graphitic substrates, graphene, graphite, buckypapers, carbon fibers, carbon fiber papers, carbon papers, graphene papers, carbon films, graphene films, graphoil and combinations thereof.

In some embodiments, the carbon layer includes a graphene film (e.g., graphene film 38 in FIG. 1B). In some embodiments, the graphene film includes, without limitation, monolayer graphene, double-layer graphene, triple-layer graphene, few-layer graphene, multi-layer graphene, graphene nanoribbons, graphene oxide, reduced graphene oxide, graphite, and combinations thereof. In some embodiments, the graphene film includes reduced graphene oxide. In some embodiments, the graphene film includes graphite.

Graphene-Carbon Nanotube Hybrid Materials

In some embodiments, the electrodes of the present disclosure include graphene-carbon nanotube hybrid materials. In some embodiments, the graphene-carbon nanotube hybrid materials include a graphene film (e.g., graphene film 38 in FIG. 1B) and vertically aligned carbon nanotubes covalently linked to the graphene film (e.g., vertically aligned carbon nanotubes 34 in FIG. 1B). In some embodiments, the vertically aligned carbon nanotubes are covalently linked to the graphene film through carbon-carbon bonds at one or more junctions between the carbon nanotubes and the graphene film (e.g., junction 36 in FIG. 1B). In some embodiments, the vertically aligned carbon nanotubes are in ohmic contact with a graphene film through the carbon-carbon bonds at the one or more junctions. In some embodiments, the one or more junctions include seven-membered carbon rings. In some embodiments, the one or more junctions are seamless.

In some embodiments, the graphene-carbon nanotube hybrid materials of the present disclosure can also include a substrate that is associated with the graphene film (e.g., substrate 40 in FIG. 1B). In some embodiments, the substrate is covalently linked to the graphene film.

Suitable substrates were described previously. For instance, in some embodiments, the substrate can include a metal substrate, such as a copper foil or a nickel foam. In some embodiments, the substrate includes a carbon-based substrate, such as a graphitic substrate. In some embodiments, the carbon-based substrate can work both as a current collector and a carbon source for the growth of carbon nanotubes.

The graphene-carbon nanotube hybrid materials of the present disclosure can include various graphene films. Suitable graphene films were described previously. For instance, in some embodiments, the graphene film can include monolayer graphene.

The vertically aligned carbon nanotubes of the present disclosure may be associated with graphene films in various manners. For instance, in some embodiments, the vertically aligned carbon nanotubes are substantially perpendicular to the graphene film (e.g., vertically aligned carbon nanotubes 34 in FIG. 1B). In some embodiments, the vertically aligned carbon nanotubes of the present disclosure are associated with graphene films at angles that range from about 45° to about 90° relative to the graphene film, while the graphene film remains parallel with the substrate (e.g., a metal upon which graphene films are grown).

In more specific embodiments, the electrodes of the present disclosure include a substrate (e.g., a metal substrate); a graphene film associated with the substrate; vertically aligned carbon nanotubes covalently linked to the graphene film through carbon-carbon bonds at one or more junctions between the vertically aligned carbon nanotubes and the graphene film; and sulfur associated with the vertically aligned carbon nanotubes. In some embodiments, the sulfur is also associated with the graphene film. In some embodiments, the graphene film is grown on the substrate. In some embodiments, the vertically aligned carbon nanotubes are grown seamlessly on the graphene film through the use of a catalyst that includes a metal and a buffer (e.g., a buffer layer).

The graphene-carbon nanotube hybrid materials of the present disclosure can be prepared by various methods. For instance, in some embodiments, the graphene-carbon nanotube hybrid materials of the present disclosure can be made by: (1) associating a graphene film with a substrate; (2) applying a catalyst (e.g., a metal and a buffer layer, such as iron and alumina, respectively) and a carbon source to the graphene film; (3) growing vertically aligned carbon nanotubes on the graphene film (e.g., from the graphene film) to form a graphene-carbon nanotube hybrid material; and (4) applying (e.g., loading) sulfur to the vertically aligned carbon nanotubes, such that the sulfur becomes associated with the vertically aligned carbon nanotubes. In some embodiments, the sulfur also becomes associated with the graphene film.

In some embodiments, the vertically aligned carbon nanotubes are grown seamlessly on the graphene film. In some embodiments, the vertically aligned carbon nanotubes are covalently linked to the graphene film through carbon-carbon bonds at one or more junctions at the interfaces between the vertically aligned carbon nanotubes and the graphene film.

In some embodiments, graphene films are associated with a substrate by transferring a pre-grown graphene film onto the substrate (See, e.g., Nano Lett., 2016, 16 (2), pp 1287-1292). In some embodiments, graphene films are associated with a substrate by growing a graphene film directly on the substrate (See, e.g., Nature Communications, 3:1225, November 2012; ACS Nano, 2013, 7 (1), pp 58-64; and Nano Lett., 2013, 13 (1), pp 72-78). In some embodiments, graphene films are grown on the substrate by chemical vapor deposition. In some embodiments, graphene films can be grown on the substrate from various carbon sources, such as gaseous or solid carbon sources.

Various catalysts may be applied to a graphene film to grow vertically aligned carbon nanotubes. For instance, in some embodiments, catalysts may include a metal (e.g., iron) and a buffer (e.g., an alumina layer). In some embodiments, the metal (e.g., iron) and buffer (e.g., alumina layer) can be grown from nanoparticles (e.g., iron alumina nanoparticles). In some embodiments, the metals can include, without limitation, metal oxides, metal chalcogenides, iron nanoparticles (e.g., Fe₃O₄), and combinations thereof.

In some embodiments, the buffer is in the form of a layer. In some embodiments, the buffer includes aluminum oxides (e.g., Al₂O₃). In some embodiments, the metal and buffer are sequentially deposited onto a graphene film by various methods, such as electron beam deposition or wet-chemical deposition from water or organic solvents.

Carbon sources may be applied to a graphene film by various methods in order to grow vertically aligned carbon nanotubes. For instance, in some embodiments, carbon sources (e.g., ethene or ethyne) may be deposited onto the graphene film by various methods, such as chemical vapor deposition. In some embodiments, the graphene film can be grown on a substrate from various carbon sources, such as gaseous or solid carbon sources.

Additional embodiments of graphene-carbon nanotube hybrid materials and methods of making the hybrid materials are described in an additional PCT application by Applicants, which has been published as WO 2013/119,295. Additional embodiments of methods of growing graphene films are disclosed in Applicants' U.S. Pat. No. 9,096,437, U.S. Pat. Pub. No. 2014/0014030, and U.S. Pat. Pub. No. 2014/0178688. Additional catalysts for growing vertically aligned carbon nanotubes are disclosed in U.S. Provisional Pat. App. No. 62/276,126. The entirety of each of the aforementioned applications is incorporated herein by reference.

Application of Sulfur to Vertically Aligned Carbon Nanotubes

Various methods may be utilized to apply sulfur to vertically aligned carbon nanotubes. For instance, in some embodiments, the applying occurs by filtration, ultrafiltration, coating, spin coating, spraying, spray coating, patterning, mixing, blending, loading, ball-milling methods, thermal activation, electro-deposition, electrochemical deposition, electron beam evaporation, cyclic voltammetry, doctor-blade coating, screen printing, gravure printing, direct write printing, inkjet printing, mechanical pressing, melting, melt diffusion, wet chemistry methods, solution-based methods, freeze-drying methods, hydrothermal-based methods, sputtering, atomic-layer deposition, and combinations thereof.

In some embodiments, the applying occurs by melt diffusion. In some embodiments, the applying occurs by melt diffusion followed by melting. In some embodiments, the melting occurs at temperatures above 100° C. In some embodiments, the melting occurs at temperatures of about 150° C. In some embodiments, the melting temperature (e.g., 150° C.) is retained for several hours. In more specific embodiments, the melting temperature is retained for 10 hours.

In some embodiments, the applying occurs by melting sulfur over a surface of vertically aligned carbon nanotubes. Thereafter, the sulfur can become associated with the vertically aligned carbon nanotubes during the wetting of the vertically aligned carbon nanotubes by the liquid sulfur. In some embodiments, the liquid sulfur penetrates the channels between the vertically aligned carbon nanotubes. In some embodiments, the liquid sulfur becomes trapped by the defects associated with vertically aligned carbon nanotubes or graphene-carbon nanotube hybrid materials. In some embodiments, the liquid sulfur becomes trapped at inter-tube spaces between vertically aligned carbon nanotubes.

The application of sulfur to vertically aligned carbon nanotubes can occur at various times. For instance, in some embodiments, the applying occurs during electrode fabrication. In some embodiments, the applying occurs after electrode fabrication.

Association of Sulfur with Vertically Aligned Carbon Nanotubes

Sulfur can become associated with vertically aligned carbon nanotubes in various manners. For instance, in some embodiments, the sulfur becomes diffused throughout the vertically aligned carbon nanotubes. In some embodiments, sulfur becomes diffused throughout the bundles of vertically aligned carbon nanotubes.

In some embodiments, sulfur becomes dispersed on surfaces of the vertically aligned carbon nanotubes. In some embodiments, sulfur forms a coating on the surfaces of the vertically aligned carbon nanotubes. In some embodiments, sulfur becomes associated with the vertically aligned carbon nanotubes in the form of a film. In some embodiments, the film is on the surface of the vertically aligned carbon nanotubes.

In some embodiments, the sulfur becomes diffused throughout the vertically aligned carbon nanotubes and dispersed on surfaces of the vertically aligned carbon nanotubes. In some embodiments, sulfur can become associated with vertically aligned carbon nanotubes in a uniform manner. In some embodiments, sulfur becomes associated with the vertically aligned carbon nanotubes without forming aggregates. In some embodiments, sulfur becomes associated with the vertically aligned carbon nanotubes and forms aggregates. In some embodiments, sulfur becomes immobilized on the surfaces of the vertically aligned carbon nanotubes.

In some embodiments, the sulfur becomes associated with vertically aligned carbon nanotubes by forming at least one of sulfur-carbon bonds, disulfide bonds, and combinations thereof. In some embodiments, the sulfur becomes associated with vertically aligned carbon nanotubes through polysulfide interactions with the vertically aligned carbon nanotubes (e.g., through van der Waals interactions). Additional modes of associations can also be envisioned.

The electrodes of the present disclosure may include various amounts of sulfur. For instance, in some embodiments, the sulfur constitutes from about 35 wt % to about 90 wt % of the electrode (e.g., mass of sulfur divided by the whole mass of sulfur and the vertically aligned carbon nanotube structure). In some embodiments, the sulfur constitutes from about 35 wt % to about 65 wt % of the electrode. In some embodiments, the sulfur constitutes more than about 60 wt % of the electrode. In some embodiments, the sulfur constitutes from about 60 wt % to about 75 wt % of the electrode. In some embodiments, the sulfur constitutes from about 50 wt % to about 90 wt % of the electrode. In some embodiments, the sulfur constitutes from about 65 wt % to about 90 wt % of the electrode. In some embodiments, the sulfur constitutes from about 50 wt % to about 200 wt % of the electrode. In some embodiments, the sulfur constitutes from about 65 wt % to about 200 wt % of the electrode. In some embodiments, the sulfur constitutes more than about 100 wt % of the electrode.

Electrode Structures and Properties

The electrodes of the present disclosure can have various structures. For instance, in some embodiments, the electrodes of the present disclosure are in the form of films, sheets, papers, mats, scrolls, conformal coatings, foams, sponges, and combinations thereof. In some embodiments, the electrodes of the present disclosure have a three-dimensional structure (e.g., foams and sponges). In some embodiments, the electrodes of the present disclosure have a two-dimensional structure (e.g., films, sheets and papers). In some embodiments, the electrodes of the present disclosure are in the form of flexible electrodes.

The electrodes of the present disclosure can serve various functions. For instance, in some embodiments, the electrodes of the present disclosure can serve as an anode. In some embodiments, the electrodes of the present disclosure can serve as a cathode. In some embodiments, the electrodes of the present disclosure can be used as binder-free and additive-free electrodes, such as cathodes.

Different components of the electrodes of the present disclosure can serve various functions. For instance, in some embodiments, the vertically aligned carbon nanotubes serve as the active layer of the electrodes (e.g., active layers of cathodes and anodes). In other embodiments, the sulfur serves as the electrode active layer while vertically aligned carbon nanotubes serve as a current collector. In some embodiments, vertically aligned carbon nanotubes serve as a current collector in conjunction with a substrate (e.g., a nickel substrate associated with a graphene film).

The electrodes of the present disclosure can have various advantageous properties. For instance, in some embodiments, the electrodes of the present disclosure have surface areas that are more than about 650 m²/g. In some embodiments, the electrodes of the present disclosure have surface areas that are more than about 2,000 m²/g. In some embodiments, the electrodes of the present disclosure have surface areas that range from about 2,000 m²/g to about 3,000 m²/g. In some embodiments, the electrodes of the present disclosure have surface areas that range from about 2,000 m²/g to about 2,600 m²/g. In some embodiments, the electrodes of the present disclosure have a surface area of about 2,600 m²/g.

In some embodiments, a carbon layer (e.g., graphene film) that is in conformal contact with a substrate (e.g., a metal substrate) can prevent the formation of oxides between the vertically aligned carbon nanotubes and substrates. This in turn can prevent the formation of diodes at a base point, thereby enhancing conductivity between the vertically aligned carbon nanotubes and a substrate. In some embodiments, a carbon layer can prevent the reaction of sulfur with a substrate. In more specific embodiments, a carbon layer (e.g., a graphene film) can protect a substrate (e.g., a nickel substrate) and react with a melting sulfur.

The electrodes of the present disclosure can also have high specific capacities. For instance, in some embodiments, the electrodes of the present disclosure have specific capacities of more than about 400 mAh/g. In some embodiments, the electrodes of the present disclosure have specific capacities of more than about 800 mAh/g. In some embodiments, the electrodes of the present disclosure have specific capacities of more than about 1,500 mAh/g. In some embodiments, the electrodes of the present disclosure have specific capacities ranging from about 400 mAh/g to about 2,500 mAh/g.

In some embodiments, the electrodes of the present disclosure retain at least 90% of their specific capacity after more than about 100 cycles. In some embodiments, the electrodes of the present disclosure retain at least 90% of their specific capacity after more than about 100 cycles. In some embodiments, the electrodes of the present disclosure retain at least 90% of their specific capacity after more than about 200 cycles. In some embodiments, the electrodes of the present disclosure retain at least 90% of their specific capacity after more than about 500 cycles.

The electrodes of the present disclosure can also have high Coulombic efficiencies. For instance, in some embodiments, the electrodes of the present disclosure have Coulombic efficiencies of more than about 90% after more than about 100 cycles. In some embodiments, the electrodes of the present disclosure have Coulombic efficiencies of more than about 95% after more than about 100 cycles. In some embodiments, the electrodes of the present disclosure have Coulombic efficiencies of more than about 98% after more than about 100 cycles. In some embodiments, the electrodes of the present disclosure have Coulombic efficiencies of more than about 99% after more than about 100 cycles.

In some embodiments, the electrodes of the present disclosure have Coulombic efficiencies of more than about 90% after more than about 500 cycles. In some embodiments, the electrodes of the present disclosure have Coulombic efficiencies of more than about 95% after more than about 500 cycles. In some embodiments, the electrodes of the present disclosure have Coulombic efficiencies of more than about 98% after more than about 500 cycles. In some embodiments, the electrodes of the present disclosure have Coulombic efficiencies of more than about 99% after more than about 500 cycles.

The electrodes of the present disclosure can also have high discharge capacities. In some embodiments, the electrodes of the present disclosure have discharge capacities ranging from about 350 mAh/g to about 1,500 mAh/g. In some embodiments, the electrodes of the present disclosure have discharge capacities ranging from about 750 mAh/g to about 1,000 mAh/g. In some embodiments, the electrodes of the present disclosure have specific capacities ranging from about 400 mAh/g to about 2,500 mAh/g.

Incorporation into Energy Storage Devices

The methods of the present disclosure can also include a step of incorporating the electrodes of the present disclosure as a component of an energy storage device. Additional embodiments of the present disclosure pertain to energy storage devices that contain the electrodes of the present disclosure.

The electrodes of the present disclosure can be utilized as components of various energy storage devices. For instance, in some embodiments, the energy storage device includes, without limitation, capacitors, lithium-sulfur capacitors, batteries, photovoltaic devices, photovoltaic cells, transistors, current collectors, fuel cell devices, water-splitting devices, and combinations thereof.

In some embodiments, the energy storage device is a capacitor. In some embodiments, the capacitor includes, without limitation, lithium-ion capacitors, super capacitors, micro supercapacitors, two-electrode electric double-layer capacitors (EDLC), pseudo capacitors, and combinations thereof.

In some embodiments, the energy storage device is a battery (e.g., battery 50 in FIG. 1C). In some embodiments, the battery includes, without limitation, rechargeable batteries, non-rechargeable batteries, micro batteries, lithium-ion batteries, lithium-sulfur batteries, lithium-air batteries, sodium-ion batteries, sodium-sulfur batteries, sodium-air batteries, magnesium-ion batteries, magnesium-sulfur batteries, magnesium-air batteries, aluminum-ion batteries, aluminum-sulfur batteries, aluminum-air batteries, calcium-ion batteries, calcium-sulfur batteries, calcium-air batteries, zinc-ion batteries, zinc-sulfur batteries, zinc-air batteries, and combinations thereof.

In some embodiments, the energy storage device is a lithium-sulfur battery. In some embodiments, the energy storage device is a capacitor. In some embodiments, the capacitor is a lithium-sulfur capacitor.

The electrodes of the present disclosure can be utilized as various components of energy storage devices. For instance, in some embodiments, the electrodes of the present disclosure are utilized as a cathode in an energy storage device (e.g., cathode 52 in battery 50, as illustrated in FIG. 1C). In some embodiments, the electrodes of the present disclosure are utilized as anodes in an energy storage device (e.g., anode 56 in battery 50, as illustrated in FIG. 1C).

In some embodiments, the electrodes of the present disclosure include a graphene-carbon nanotube hybrid material that is utilized as an anode in an energy storage device. In some embodiments, the anodes of the present disclosure may be associated with various cathodes. For instance, in some embodiments, the cathode is a transition metal compound. In some embodiments, the transition metal compound includes, without limitation, LiₓCoO₂, LiₓFePO₄, LiₓNiO₂, LiₓMnO₂, LiₐNi_{b}Mn_{c}Co_{d}O₂, LiₐNi_{b}Co_{c}Al_{d}O₂, NiO, NiOOH, and combinations thereof. In some embodiments, integers a,b,c,d, and x are more than 0 and less than 1.

In some embodiments, cathodes that are utilized along with the anodes of the present disclosure include sulfur. In some embodiments, the cathode includes oxygen, such as dioxygen, peroxide, superoxide, and combinations thereof. In some embodiments, the cathode contains metal oxides, such as metal peroxides, metal superoxides, metal hydroxides, and combinations thereof. In some embodiments, the cathode includes lithium cobalt oxide. In some embodiments, the cathode includes a sulfur/carbon black cathode.

In some embodiments, the energy storage devices that contain the electrodes of the present disclosure may also contain electrolytes (e.g., electrolytes 54 in battery 50, as illustrated in FIG. 1C). In some embodiments, the electrolytes include, without limitation, non-aqueous solutions, aqueous solutions, salts, solvents, ionic liquids, additives, composite materials, and combinations thereof. In some embodiments, the electrolytes include, without limitation, lithium hexafluorophosphate (LiPF6), lithium (trimethylfluorosulfonyl) imide (LITFSI), lithium (fluorosulfonyl) imide (LIFSI), lithium bis(oxalate)borate (LiBOB), hexamethylphosphoustriamide (HMPA), and combinations thereof. In some embodiments, the electrolytes are in the form of a composite material. In some embodiments, the electrolytes include solvents, such as ethylene carbonate, diethyl carbonate, dimethyl carbonate, ethyl methyl carbonate, 1,2-dimethoxyl methane, and combinations thereof.

The electrodes of the present disclosure can provide various advantageous properties in energy storage devices. For instance, in some embodiments, carbon layers (e.g., graphene films) in electrodes serve as a linking agent between the vertically aligned carbon nanotubes and a substrate (e.g., nickel), thereby providing highly conductive electron transfer pathways during charge and discharge processes. In some embodiments, carbon layers (e.g. graphene films) can alleviate the strain between the electrode and the substrate (e.g., nickel foams) during the charge and discharge processes.

In addition, due to their large surface areas (e.g., more than 2,000 m²/g), the electrodes of the present disclosure can accommodate large amounts of sulfur (e.g., more than 200 wt %). The sulfur can in turn enhance ion (e.g., lithium) diffusivity within the energy storage device. Moreover, the compact structure of the electrodes can provide fast ion (e.g., lithium) transport within the energy storage devices while minimizing volume expansion and pulverization.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Three-Dimensional Covalent Bonded Graphene and Carbon Nanotubes for High-Performance Lithium-Sulfur Batteries

In this Example, Applicants disclose a method of making graphene-carbon nanotube hybrid materials that are associated with sulfur (referred to herein as “hybrid materials” or “GCNT/S”). A three-dimensional covalent bonded graphene and carbon nanotubes (GCNTs) bundle structure was applied onto a substrate (e.g., a porous nickel foam or a metal substrate). The substrate was then used for sulfur loading. In particular, the process included the following steps: (1) associating a graphene film with a substrate; (2) applying a catalyst and a carbon source to the graphene film; (3) growing carbon nanotubes on the graphene film to form the graphene-carbon nanotube hybrid material; and (4) associating the graphene-carbon nanotube hybrid material with sulfur. The sulfur was associated with the graphene-carbon nanotube hybrid material by loading sulfur onto the formed graphene-carbon nanotube hybrid material. In some instances, the sulfur diffused into the hybrid material.

The graphene films in the hybrid materials can serve as a linking agent between the carbon nanotubes (e.g., CNT bundles) and the substrate (e.g., nickel interfaces), thereby providing an optimal electron transfer framework. Moreover, the hybrid materials have a very large specific surface area of more than 2,000 m²g⁻¹. Each CNT bundle consists of numerous single-walled carbon nanotubes, thereby promising a high inner area for sulfur loading. As a result, the sulfur content in each hybrid material was larger than 70%.

When used as cathodes for a lithium-sulfur battery (Li—S) battery, the GCNT/S hybrid materials delivered optimal electrochemical performances. In some instances, the discharge voltage plateau of GCNT/S is 2.1 V, indicating high output voltage of Li—S batteries. In some instances, the first discharge specific capacity for GCNT/S cathode was as high as 2084 mAh/g, while the reversible specific capacity was 1341 mAhg⁻¹ at the second cycle with a high. Columbic efficiency of 98.9%. After 30 cycles, the capacity remained high at a value of 950 mAh/g, which was nearly 7 times higher than a LiCoO₂ cathode in LIB s.

### EXAMPLE 1.1

### Fabrication of GCNT/S Hybrid Materials

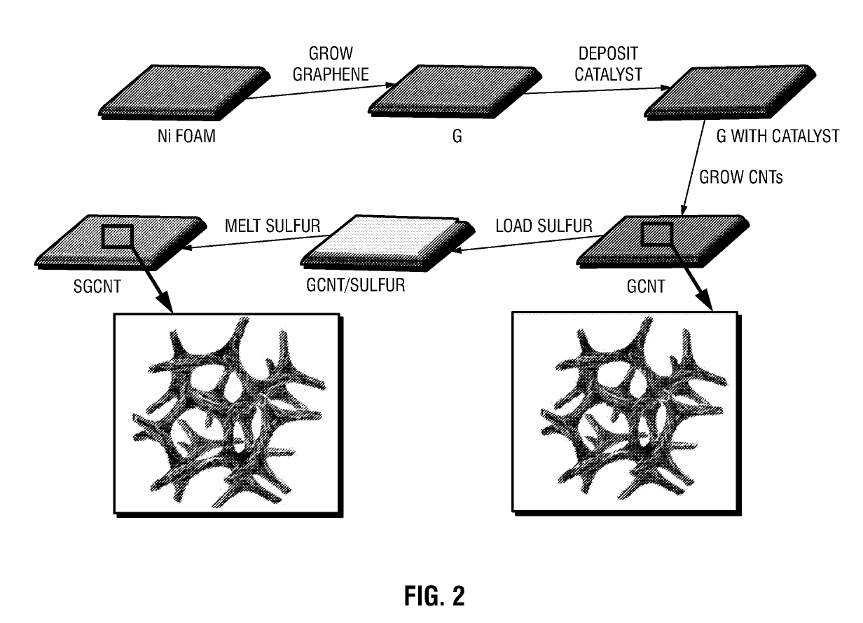

FIG. 2 provides a scheme of fabricating GCNT/S hybrid materials on porous nickel foam. The porous nickel foam was purchased from Heze Tianyu Technology Development Company. The thickness and the areal density are 1.2 mm and 320 g/m², respectively. Multi-layered graphene was grown on the Ni foam by the chemical vapor deposition method. The Ni foam was first annealed under H₂ flow for 10 minutes at 1000° C. This was followed by 50 sccm CH₄ and 200 sccm Ar for another 10 minutes. Next, 1 nm Fe and 3 nm Al₂O₃ were deposited in series on the graphene as the catalyst and the buffer layer by e-beam evaporation, respectively. The CNT growth was done under reduced pressure in a water-assisted hot filament furnace. The flow rate of acetylene and hydrogen were 2 and 210 sccm, respectively. The flow rate for the bubbling hydrogen was 200 sccm. The sample was first annealed at 25 Ton for 30 seconds, during which a tungsten filament was activated by turning the working power of 30 W to reduce the catalyst. Next, the pressure was reduced to ˜8 Ton and the hot filament was switched off immediately to start the nanotube growth for an additional 5 minutes to form bundle like CNTs on Ni foam.

GCNT growth has been described in Applicants' prior publications, including the following: Zhu et al., “A Seamless Three-Dimensional Carbon Nanotube Graphene Hybrid Material,” Nature Commun. 2012, 3, 1225; Yan et al., “Three-Dimensional Metal Graphene Nanotube Multifunctional Hybrid Materials,” ACS Nano 2013, 7, 58-64; Lin et al., “3-Dimensional Graphene Carbon Nanotube Carpet-Based Microsupercapacitors with High Electrochemical Performance,” Nano Lett. 2013, 13, 72-78; and WO 2013/119,295A1 (PCT/US2012/065894). The entirety of each of the aforementioned publications are incorporated herein by reference.

### EXAMPLE 1.2

### Fabrication of GCNT/S Electrodes

As also illustrated in FIG. 2, GCNT/S cathodes were fabricated by a melt-diffusion method. 3-6 mg of sulfur, which depends on the mass of the GCNTs, was dispersed on the surface of GCNT Ni foam to a thin layer. Next, the samples were centered at the furnace under Ar at 150° C. for 1 hour at atmospheric pressure. The typical mass loading of sulfur was about 72%.

### EXAMPLE 1.3

### Fabrication of Li—S Batteries

The formed GCNT/S electrodes were directly applied as cathodes in lithium-sulfur (Li—S) batteries. The CR2032 coin-type cells were assembled with lithium metal foil as the counter electrode. The electrolyte was 1 M lithium bis(trifluoromethane) sulfonamide (LiTFSI) dissolved in a mixture of 1,3-dioxolane (DOL) and dimethyoxyethane (DME) (1:1 vol:vol). The separator was a Celgard 2500 membrane.

### EXAMPLE 1.4

### Characterization of GCNT/S Electrodes

Applicants have demonstrated that GCNT/S electrodes provide various advantageous properties. For instance, the GCNT/S electrodes provide a highly conductive three-dimensional framework. Moreover, the highly conductive substrate plays a key role in energy storage devices.

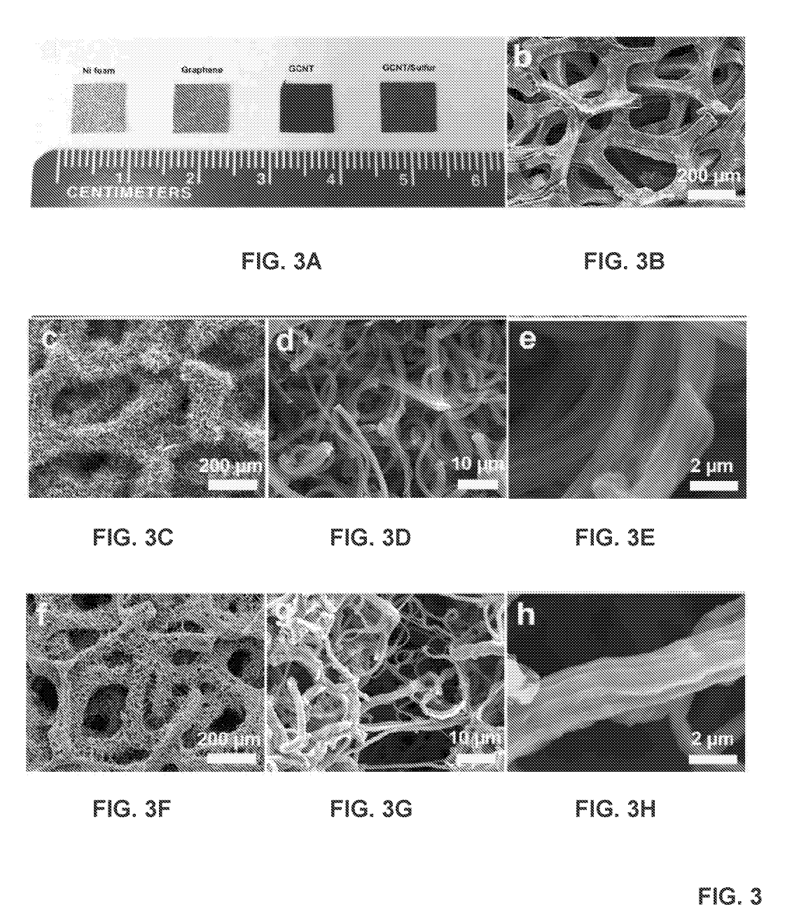

Furthermore, the GCNT/S electrodes provide high specific surface areas. In particular, the GCNT bundles raise the Fe/Al₂O₃ catalyst layer during the growth process and uniformly stretch out from the Ni framework. Each GCNT bundle with a size of 2 μm consists of numerous CNTs (FIGS. 3C-E). Based on Applicants' previous publication, the specific surface area of this material is more than 2,000 m²/g (Nature Communications 2012, 3, 1225).

Moreover, the GCNT/S electrodes have high sulfur loading. During the melt-diffusion method, Applicants can control the mass loading of sulfur in the GCNT/S electrodes. The mass loading of sulfur can be as high as 89%, which is higher than the most published Li—S batteries papers. Some selected samples and their corresponding sulfur content are listed in Table 1.

TABLE 1
The mass loading information of GCNTs and sulfur and
the corresponding sulfur content in some samples.

| | Samples | | | | | | |
|---|---|---|---|---|---|---|---|
| | 20 | 21 | 24 | 25 | 26 | 27 | 28 |
| GCNTs (mg) | 0.785 | 0.8165 | 0.5853 | 0.5017 | 0.7931 | 0.5539 | 0.682 |
| Sulfur (mg) | 3 | 2.5 | 1.5 | 1.1 | 2.1 | 1.5 | 1.4 |
| Sulfur content (%) | 89% | 75% | 72% | 67% | 73% | 73% | 67% |

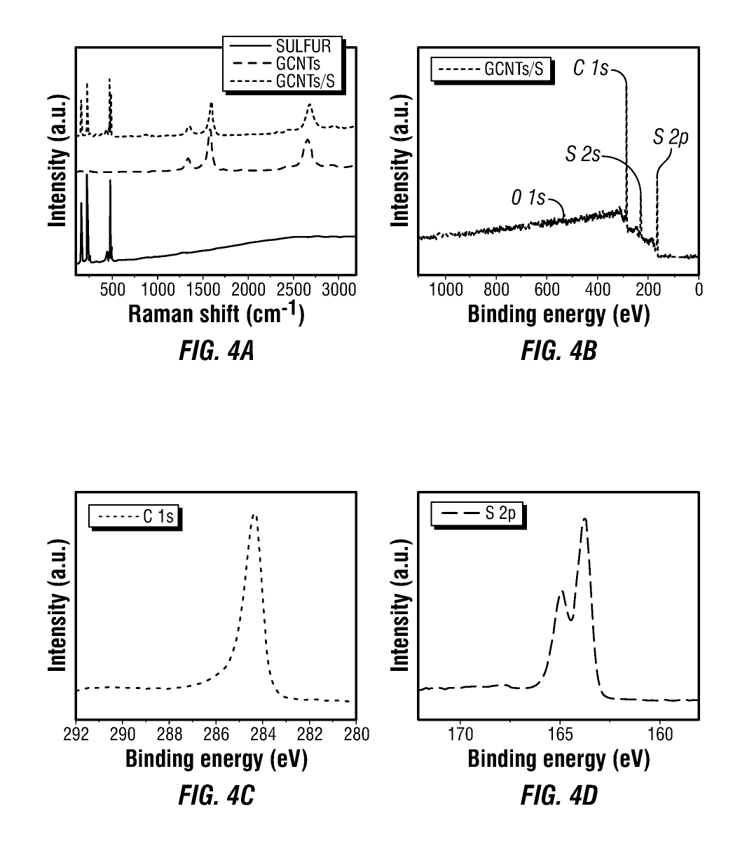

The crystal structure and composition of GCNT/S electrodes were also characterized by Raman spectroscopy (FIG. 4A). GCNT shows a strong G peak at ˜1580 cm⁻¹ and a 2D peak at ˜2655 cm⁻¹. In addition, the G/D ratio of the carbon nanotubes (CNTs) is about 3, suggesting the presence of few defects. Furthermore, the existence of sulfur peaks in GCNT/S electrodes indicates the successful loading of sulfur on the GCNT framework. This can be further confirmed by the x-ray photoelectron spectroscopy (XPS) data in FIGS. 4B-D.

### Example 1.5

### Characterization of GCNT/S Electrodes in Li—S Batteries

Applicants also observed optimal electrochemical performance of GCNT/S electrodes in Li—S batteries from a preliminary study. The electrolytes utilized during the experiments included LiTFSI (1M) and LiNO₃ (0.16 M) in DME:DOL (1:1 vol:vol).

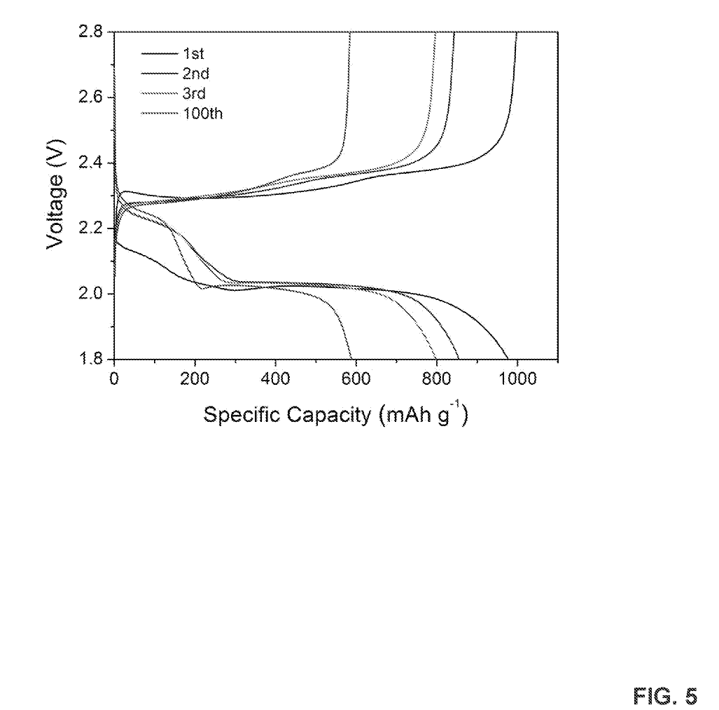

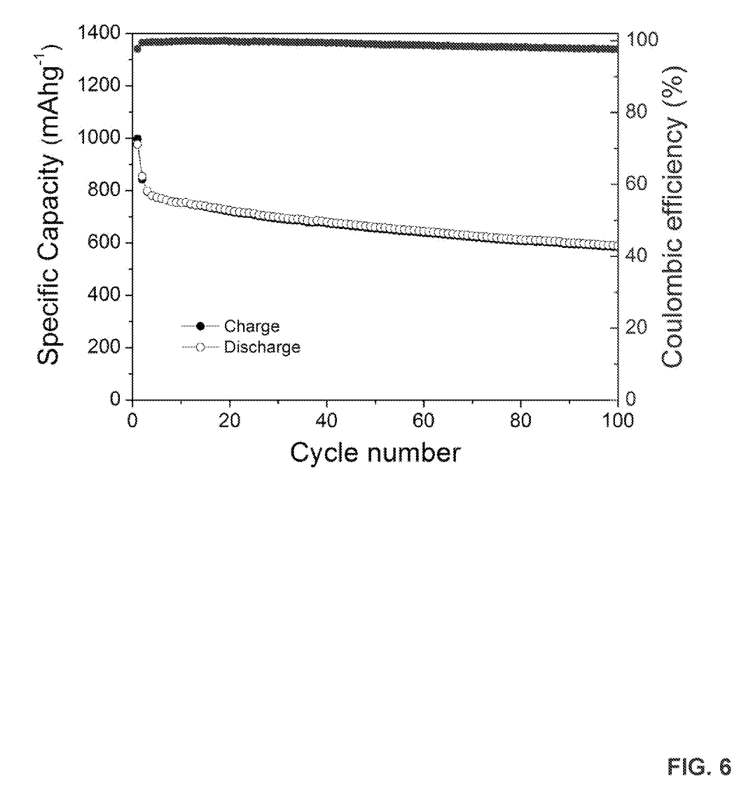

The GCNT/S cathode with the sulfur content of 72% delivers large output voltage and high specific capacity. The discharge voltage plateau of GCNT/S is 2.1 V, indicating high output voltage of Li—S batteries (FIG. 5). The first discharge specific capacity for GCNT/S cathode is as high as 2084 mAh/g, and the reversible specific capacity is 1341 mAh/g at the second cycle with high Columbic efficiency of 99%. A 60% capacity retention was observed after 100 cycles (FIG. 6).

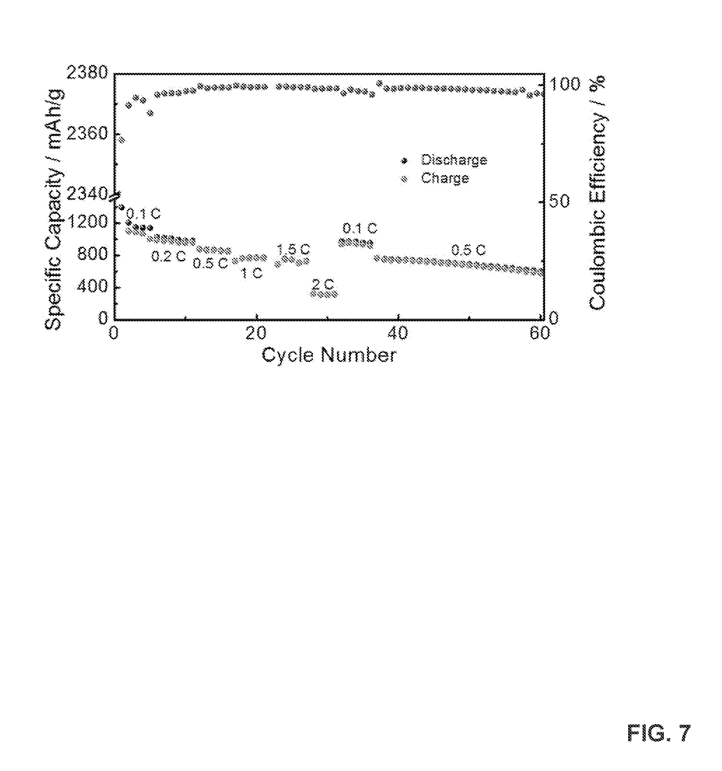

Additional data relating to the rate performance of GCNT/S cathodes in Li—S batteries is summarized in FIG. 7. In particular, FIG. 7 shows the rate capability of the GCNT/S cathodes. The discharge capacities are around 1119, 1000, 873, 764, 747 and 350 mAh/g at 0.1, 0.2, 0.5, 1.0, 1.5 and 2 C, respectively. As the current density was abruptly switched back to 0.1 C, the discharge capacity returned to 966 mAh/g, indicating the good stability and the high conductivity of GCNT/S at various rates.

In summary, the GCNT/S cathodes can have various advantageous properties over existing sulfur electrodes for Li—S batteries. For instance, GCNT/S has higher electrical and ionic conductivity due to two covalent bonded interfaces of metal/graphene and graphene/CNTs, which reduce the contact resistance compared with other electrode (e.g., cathode) materials. Moreover, a large sulfur loading amount is present due to the high specific surface area of GCNTs. In addition, the CNT bundles act as sulfur surface adhesion sites in GCNT/S electrodes.

From the comparison of the large magnification scanning electron microscopy (SEM) images of GCNT (FIG. 3E) and GNCT/S (FIG. 3H), it can be clearly seen that sulfur diffused into each GCNT bundle. These two properties can promise high capacity and large energy density for Li—S batteries.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1-69. (canceled)

70. An electrode comprising:
a conductive substrate;
at least one graphene layer in conformal contact with the conductive substrate;
a carbon-nanotube layer extending from and in ohmic contact with the at least one graphene layer; and
sulfur diffused within the carbon-nanotube layer.

71. The electrode of claim 70, wherein the at least one graphene layer consists essentially of few-layer graphene.

72. The electrode of claim 70, wherein the carbon-nanotube layers consist essentially of single-walled carbon nanotubes.

73. The electrode of claim 70, further comprising a sulfur layer dispersed on a surface of the carbon-nanotube layer.

74. The electrode of claim 73, wherein the sulfur diffused within the carbon-nanotube layer and the sulfur layer constitutes over 60% of a combined mass of the graphene layer, the carbon-nanotube layer, the sulfur diffused within the carbon-nanotube layer, and the sulfur layer.

75. The electrode of claim 70, further comprising a covalent interface between the at least one graphene layer and the carbon-nanotube layer.

76. The electrode of claim 70, wherein the carbon-nanotube layer consists essentially of vertically aligned carbon nanotubes.

77. The electrode of claim 76, the vertically aligned carbon nanotubes comprising defects terminated by at least one of atoms and functional groups.

78. The electrode of claim 70, wherein the carbon-nanotube layer is in a form of an array of superlattices.

79. The electrode of claim 70, wherein the carbon nanotubes are grouped in nanotube bundles.

80. The electrode of claim 79, wherein the nanotube bundles have inter-tube spacings in a range of from three angstroms to twenty angstroms.

81. The electrode of claim 79, further comprising channels separating the nanotube bundles.

82. The electrode of claim 81, wherein the channels range from five angstroms to twenty angstroms in width.

83. The electrode of claim 70, further comprising a van der Waals interface between the conductive substrate and the at least one graphene layer.

84. The electrode of claim 70, wherein the conductive substrate is covalently bonded to the at least one graphene layer.

85. The electrode of claim 70, wherein the conductive substrate is porous.

86. The electrode of claim 85, wherein the conductive substrate comprises a foam.

87. An electrode comprising:
a carbon-based substrate, wherein the carbon-based substrate is selected from the group consisting of a network of graphitic substrates, carbon fibers, graphene, graphene nanoribbons, carbon nanotubes, and combinations thereof;
a carbon-nanotube layer extending from and in ohmic contact with the substrate; and
sulfur diffused within the carbon-nanotube layer.
